(19) United States
(12) Patent Application Publication
(10) Pub. No.: US 2012/0208661 A1
(43) Pub. Date: Aug. 16, 2012

(54) Gearbox for Electric Motors

(75) Inventors: Jean-François Lavigne, La Prairie (CA); François Messier, Varennes (CA)

(73) Assignee: LTS Marine Inc.

(21) Appl. No.: 13/396,810

(22) Filed: Feb. 15, 2012

Related U.S. Application Data
(60) Provisional application No. 61/442,903, filed on Feb. 15, 2011.

(51) Int. Cl. F16H 7/02; F16H 7/08

(52) U.S. Cl. 474/84

(57) ABSTRACT

A gearbox allowing the interconnection of two electric motors to an output shaft is described herein. The gearbox includes a tensioning assembly moving the output shaft away from input shafts.

### FIELD

The present invention relates to gearboxes. More specifically, the present invention is concerned with a gearbox for electric motor.

### BACKGROUND

Gearboxes are well known in the art. They usually provide speed and torque conversion between an input shaft and an output shaft.

### BRIEF DESCRIPTION OF THE DRAWINGS

In the appended drawings:

FIG. 1 is a perspective view of a gearbox according to an illustrative embodiment; two electric motors being shown mounted to the gearbox;

FIG. 2 is a perspective view of the gearbox of FIG. 1 where the cover has been removed;

FIG. 3 is an exploded view of the gearbox of FIG. 1;

FIG. 4 is a sectional view illustrating the output shaft and the output shaft tensioning mechanism; and

FIG. 5 is a partial rear perspective view of the gearbox of FIG. 1.

### DETAILED DESCRIPTION

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

In the present specification and in the appended claims, various terminology which is directional, geometrical and/or spatial in nature such as “longitudinal”, “horizontal”, “front”, rear”, “upwardly”, “downwardly”, etc. is used. It is to be understood that such terminology is used for ease of description and in a relative sense only and is not to be taken in any way as a limitation upon the scope of the present disclosure.

Other objects, advantages and features of the gearbox will become more apparent upon reading of the following non-restrictive description of illustrative embodiments thereof, given by way of example only with reference to the accompanying drawings.

According to an illustrative embodiment, there is provided a gearbox including:

first and second input shafts including respective first and second input pulleys;

an output shaft including first and second output pulleys;

first and second interconnecting elements respectively interconnecting the first and second input pulleys to the first and second output pulleys; and

a tension adjusting assembly so configured as to adjust the tension of the first and second interconnecting elements.

Generally stated, an illustrative embodiment describes a gearbox used to interconnect two electric motors, each having an input shaft, to an output shaft. For example, such a gearbox can be used in a watercraft. A tensioning assembly is provided to tension the driving elements interconnecting the two input shafts and the output shaft.

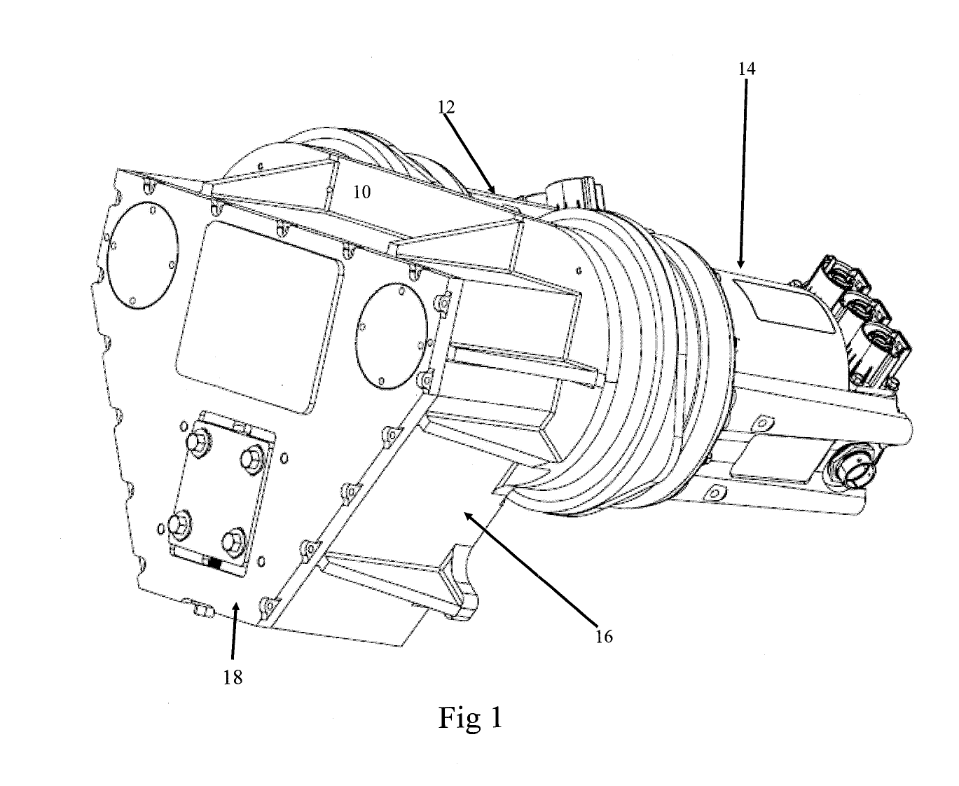

FIG. 1 of the appended drawings illustrates a gearbox 10, according to an illustrative embodiment, to which two electric motors 12 and 14 are removably mounted. The gearbox 10 includes a casing 16 provided with a removable cover 18.

The casing 16 includes a plurality of stiffening ribs, both internal and external. One skilled in the art would understand that these ribs are not essential and depend on the strength of the walls of the casing.

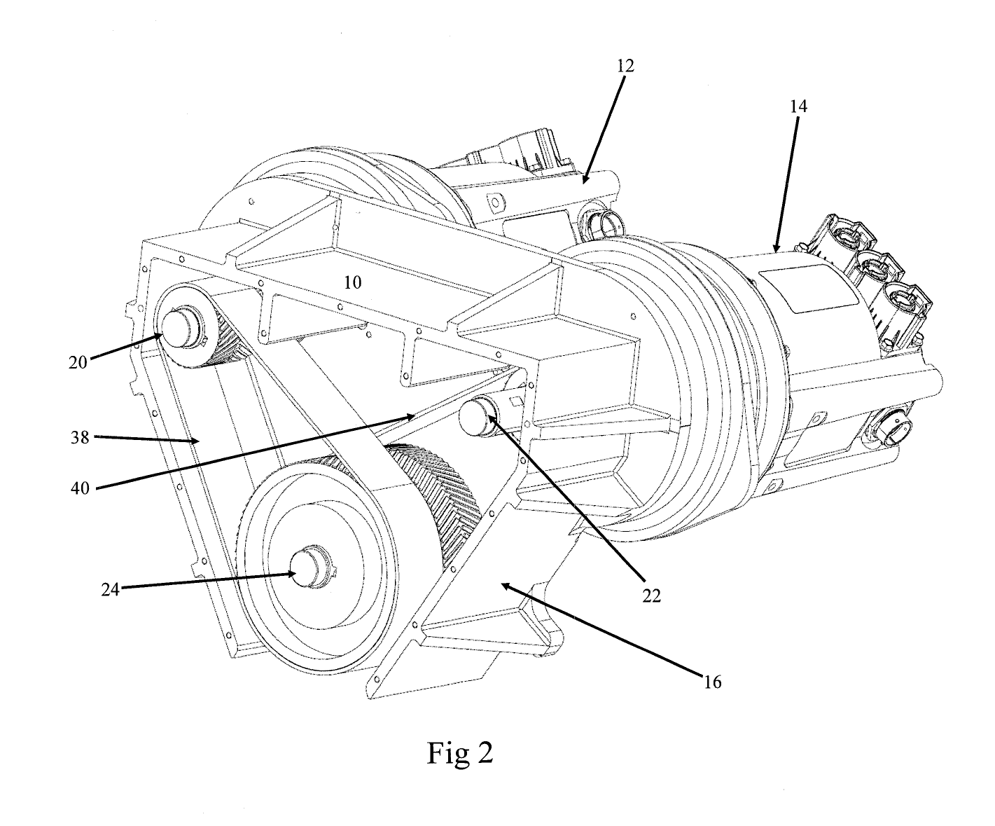

FIG. 2 illustrates the gearbox 10 where the cover 18 has been removed. As can be seen from this figure, the gearbox 10 includes a first input shaft 20 to which the first electric motor 12 is connected, a second input shaft 22 to which the second electric motor 14 is connected and an output shaft 24. The shafts 20, 22 and 24 being so positioned as to generally define a triangle.

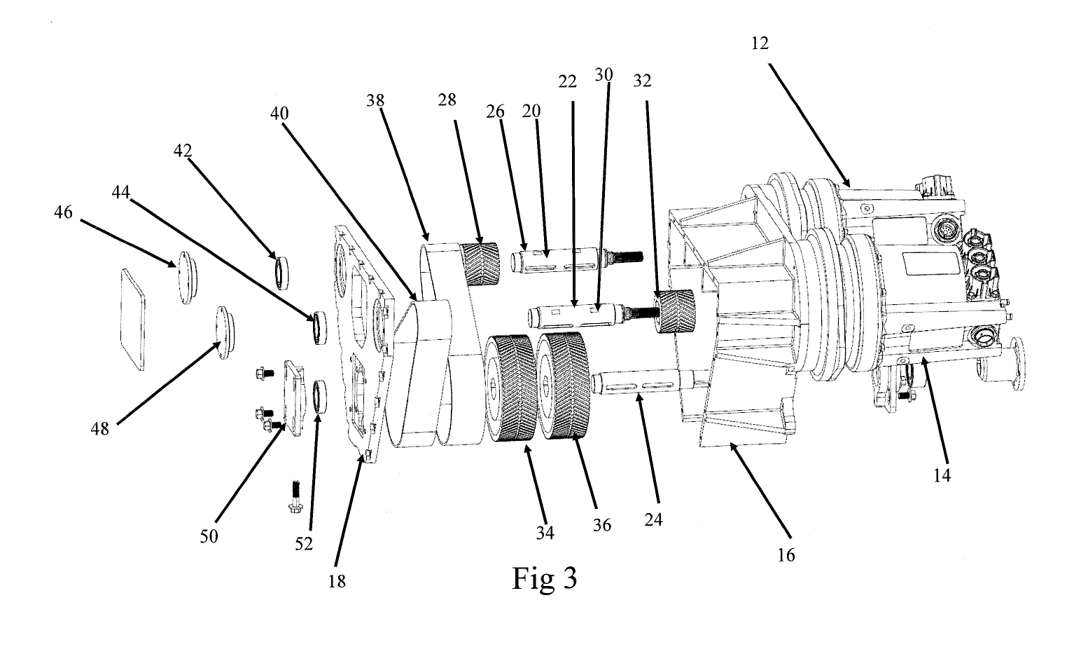

As can be better seen in FIG. 3, which is an exploded view of the gearbox 10, the distal end 26 of the input shaft 20 is provided with a first input pulley 28 and the proximate end 30 of the second input shaft 22 is provided with a second input pulley 32. On the other hand, the output shaft 24 is provided with identical first and second output pulleys 34 and 36. Key and keyway arrangements are used to prevent the rotation of the pulleys onto their respective shaft.

A first belt 38 is used to interconnect the first input pulley 28 to the first output pulley 34 and a second belt 40 is used to interconnect the second input pulley 32 to the second output pulley 36.

Accordingly, there is no interference between the first and second belts 38 and 40. The first input shaft 20 is fixedly mounted to the cover 18 via a bearing 42 while the second input shaft 22 is mounted to the cover 18 via a bearing 44. Covers 46 and 48 allow access to the bearings 42 and 44.

The output shaft 24 is mounted to a first adjusting bracket 50 via a bearing 52.

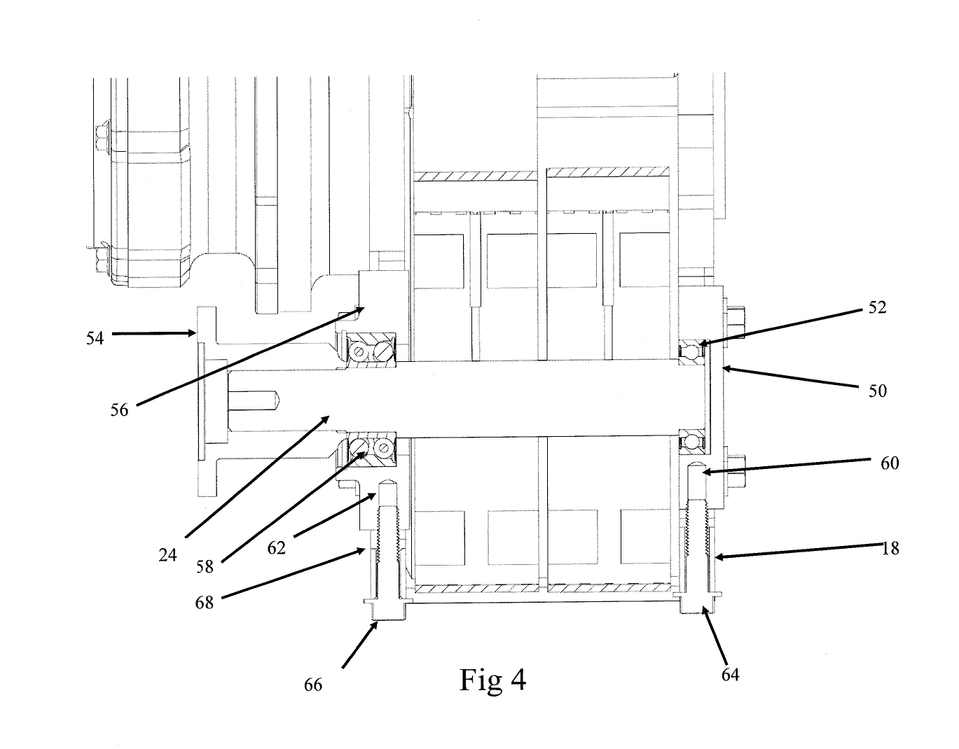

As can be better seen from FIG. 4, the proximate end 54 of the output shaft 24 is mounted to a second adjustment bracket 56 via a bearing 58. One skilled in the art will understand that the proximate end 54 of the output shaft 24 is used to connect the gearbox 10 to other elements. In the case of a watercraft, for example, the proximate end 54 is connected to a propeller (not shown) via a propeller shaft (also not shown). Accordingly, the shape and size of the proximate end 54 of the output shaft are chosen according to the intended use of the transmission.

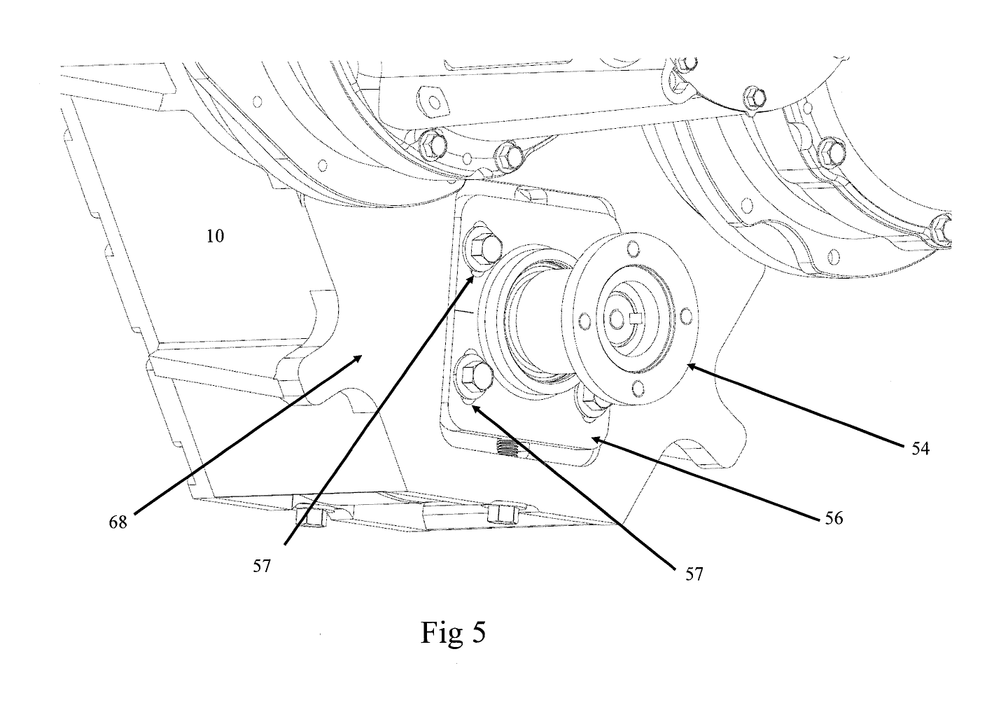

As can be better seen from FIG. 5, which illustrates a portion of the rear wall 68 of the casing 16 of the gearbox 10, the first and second adjustment brackets 50 and 56 include four oblong adjustment apertures 57 allowing fasteners therethrough, the purpose of which will be described hereinbelow.

Returning to FIG. 4, the brackets 50, 56 have respective threaded apertures 60, 62 so configured and sized as to receive adjustment bolts 64, 66, respectively going through the cover 18 and the rear wall 68 of the gearbox 10.

Accordingly, the tension of the belts 38 and 40 can be adjusted by tightening the bolts 64 and 66, which pulls the brackets 50 and 56, and hence the output shaft 24, away from the input shafts 20 and 22. When the desired tension is obtained one simply has to tighten the fasteners respectively securing the brackets 50 and 56 to the cover 18 and to the rear wall 68 of the gearbox 10.

Using multiple electric motors and a gearbox allows one to use smaller and therefore less expensive electric motors. Furthermore, the motor redundancy allows one to be operational using only one of the motors should the other motor fail.

It is to be noted that while belts have been described herein to interconnect the input shafts to the output shaft, other interconnection elements, such as, for example chains, could be used. Of course, one skilled in the art will understand that should chains be used, adequate gears would replace the pulleys.

Also, while two output pulleys 34 and 36 are described and illustrated herein, these two output pulleys could be joined in a single output pulley.

It is also to be noted that while the gearbox described above and illustrated in the appended drawings illustrates the interconnection of two electric motors to an output shaft, more than two electric motors could be interconnected to an output shaft using a similar approach.

One skilled in the art will understand that the use of a tension adjusting assembly replaces the usual external tensioning assemblies such as spring loaded idler pulley. Accordingly, the gearbox contains less moving parts and is therefore less expensive and more reliable.

It is also to be noted that while a relatively deep casing provided with a relatively thin cover have been described and illustrated herein, a two part casing having a generally centered seam (not shown) could be used. Since the two parts of the casing may be made identical, this decreases the parts expenses. Should it be the case, a first part could be defined as the casing and a second part could be defined as the cover.

Similarly, the relatively deep casing provided with a relatively thin cover could be replaced by an extrusion that would be closed by two covers. Should it be the case, the extrusion and one cover could be defined as the casing and the other cover as the cover.

It is to be understood that the gearbox is not limited in its application to the details of construction and parts illustrated in the accompanying drawings and described hereinabove. The gearbox is capable of other embodiments and of being practiced in various ways. It is also to be understood that the phraseology or terminology used herein is for the purpose of description and not limitation. Hence, although the gearbox has been described hereinabove by way of illustrative embodiments thereof, it can be modified, without departing from the spirit, scope and nature of the subject invention.

What is claimed is:

1. A gearbox including:
first and second input shafts including respective first and second input pulleys;
an output shaft including first and second output pulleys;
first and second interconnecting elements respectively interconnecting the first and second input pulleys to the first and second output pulleys; and
a tension adjusting assembly so configured as to adjust the tension of the first and second interconnecting elements.

2. A gearbox as recited in claim 1, wherein the first and second interconnecting elements include first and second belts.

3. A gearbox as recited in claim 1, wherein the first input pulley is mounted in the vicinity of a proximate end of the first input shaft.

4. A gearbox as recited in claim 3, wherein the second input pulley is mounted in the vicinity of the distal end of the second input shaft.

5. A gearbox as recited in claim 4, wherein the first output pulley is mounted in the vicinity of the proximate end of the output shaft and wherein the second output pulley is mounted in the vicinity of the distal end of the output shaft.

6. A gearbox as recited in claim 1, wherein the first and second input pulleys are mounted to the first and second input shafts via key and keyway arrangements and wherein the output pulley is mounted to the output shaft via a key and keyway arrangement.

7. A gearbox as recited in claim 1, further comprising a casing provided with a rear wall and a removable cover facing the rear wall.

8. A gearbox as recited in claim 7, wherein the cover includes shaft-mounting apertures so configured as to receive bearings rotatably supporting the first and second input shafts.

9. A gearbox as recited in claim 7, wherein the first and second input shafts and the output shafts are so mounted between the rear wall and the removable cover as to generally define a triangle.

10. A gearbox as recited in claim 9, wherein the tension adjusting assembly includes first and second brackets respectively rotatably receiving the distal and proximate ends of the output shaft; the first bracket being so mounted to the removable cover as to be movable away from the first and second input shafts and the second bracket being so mounted to the rear wall as to be movable away from the first and second input shafts.

11. A gearbox as recited in claim 10, wherein the first and second brackets have respective threaded apertures so configured and sized as to receive adjustment bolts respectively going through the removable cover and the rear wall.

12. A gearbox as recited in claim 10, wherein the first and second brackets also includes oblong apertures through which fasteners are inserted to respectively mount the first and second brackets to the removable cover and the rear wall.

13. A gearbox as recited in claim 1, wherein the first and second input shafts are configured to be associated with electric motors.

14. A gearbox as recited in claim 13, wherein the output shaft is so configured and sized as to be connected to a propeller shaft of a watercraft.

15. A gearbox as recited in claim 7, wherein the casing and the cover are identical.

16. A gearbox as recited in claim 7, wherein the rear wall of the casing is defined by a second removable cover.
